(19) United States
(12) Patent Application Publication
(10) Pub. No.: US 2014/0172940 A1
(43) Pub. Date: Jun. 19, 2014

(54) Information Processing Method For Electronic Device Accessory, Electronic Device And Accessory Thereof

(71) Applicants: Lenovo (Beijing) Co., Ltd., Haidian District (CN); Beijing Lenovo Software Ltd., Haidian District (CN)

(72) Inventor: Binqiang Ma, Beijing (CN)

(73) Assignees: Lenovo (Beijing) Co., Ltd., Haidian District (CN); Beijing Lenovo Software Ltd., Haidian District (CN)

(21) Appl. No.: 14/107,047

(22) Filed: Dec. 16, 2013

(30) Foreign Application Priority Data
Dec. 14, 2012 (CN) 201210546378.2

(51) Int. Cl. H04L 29/08

(52) U.S. Cl. CPC H04L 67/10
USPC 709/201

(57) ABSTRACT

An information processing method of an electronic device accessory, an electronic device and an accessory thereof are described. The method includes the electronic device acquiring the unique identifier of the first accessory that the electronic device uses and first information of the application; reporting the unique identifier of the first accessory and the first information to the web server so that the web server can acquire the function information of the first accessory in the application according to the unique identifier and the first information; receiving the function information sent by the web server; configuring the function information for the first accessory so that the first accessory has the functions corresponding to the function information in the application. The present method is applicable to touch-screen electronic devices.

This application claims priority to Chinese patent application No. CN201210546378.2 filed Dec. 14, 2012, the entire contents of which are incorporated herein by reference.

### BACKGROUND

The present disclosure relates to the technical field of terminals, and more particularly to an information processing method for electronic device accessory, an electronic device and accessory thereof.

Nowadays, with the development of touch-screen technology, touch-screen electronic devices, such as phones with touch screen, tablet computers have been very widely used. People can operate the touch-screen electronic device by touching the touch screen electronic device. Users can learn, work, entertain themselves and play games and so on with the touch-screen electronic device. In order to enable a more intuitive user operation, accessories can be provided on the touch screen electronic device so as to execute the operations on the touch screen electronic device by operating the accessories.

For example, users can play chess through the touch-screen electronic device. Wherein, in order to enable a more intuitive operation, chess pieces used in the chess game can be substantiated. The user can operate the substantiated chess pieces so as to play on the screen of the touch-screen electronic device.

During the process of implementing the embodiment of the present invention, there are at least following problems in the prior art: for different applications, since the function of the accessories is single, different accessories may be required to achieve the operations of the electronic device, so the cost is high.

### SUMMARY

The present disclosure provides an information processing method of electronic device accessories, electronic device and accessory thereof, which can solve the problem in the prior art that different accessories may be required to achieve the operations of the electronic device due to the single function of the accessories, and that the cost is high.

In order to achieve the above object, the present disclosure adopts the following technical solutions:

An information processing method for electronic device accessories, applied to an electronic device and a first accessory independent of the electronic device, the method includes the following steps:

When an application is running, the electronic device acquires the unique identifier of the first accessory that the electronic device uses and first information of the application;

The electronic device reports the unique identifier of the first accessory and the first information to the web server, so that the web server can acquire the function information of the first accessory in the application according to the unique identifier and the first information;

The electronic device receives the function information sent by the web server;

The electronic device configures the function information for the first accessory so that the first accessory has the functions corresponding to the function information in the application.

An electronic device includes:

An acquisition unit, configured to acquire the unique identifier of the first accessory that the electronic device uses and the first information of an application when the application is running.

A transmission unit, configured to report the unique identifier of the first accessory and the first information to the web server, so that the web server acquires the function information of the first accessory in the application according to the unique identifier and the first information;

A receiving unit, configured to receive the function information sent by the web server;

A configuration unit, configured to configure the function information for the first accessory so that the first accessory has the functions corresponding to the function information in the application.

An electronic device accessory, the electronic device accessory has a unit identifier.

With the information processing method of the electronic device, electronic device and accessory thereof provided by the embodiment of the present disclosure, since when the application is running, the electronic device acquires the unique identifier of the first accessory that the electronic device uses and the first information of the application, and reports the unique identifier of the first accessory and the first information to the web server so that the web server can acquire the function information of the first accessory in the application according to the first unique identifier and the first information, after the electronic device receives the function information sent by the web server and configure it for the first accessory, the first accessory has the function corresponding to the function information in the application. When the first accessory is applied to different applications, it can perform the corresponding function through the function information in different applications, whereas the function of the accessory in the prior art is single and can be only applied to one application. Therefore, the present invention can lower the costs of the accessory and make the accessory functions more diverse.

### BRIEF DESCRIPTION OF THE DRAWINGS

In order to illustrate the technical solution in the embodiment of the present disclosure or in the prior art, figures to be used in the description of the embodiment or the prior art are briefly introduced. Obviously, the figures described below are only some embodiments of the present disclosure. For those skilled in the art, other figures can be obtained according to these figures without creative efforts.

FIG. 1 is a flow chart of the information processing method of the electronic device accessories provided by the embodiment of the present disclosure;

FIG. 2 is a flow chart of the information processing method of the electronic device accessories provided by another embodiment of the present disclosure;

FIG. 3 is a schematic structural view of the electronic device provided by the embodiment of the present invention.

### DETAILED DESCRIPTION

Hereinafter, embodiments of the present disclosure will be described in detail and completely with reference to the accompanying drawings. It is obvious that the embodiments described are only part of the embodiments of the present invention, but not all the embodiments. Based on the embodiments of the present invention, all other embodiments obtained by those skilled in the art without inventive efforts are within the protection scope of the present invention.

In order to make the advantages of the solution of the present disclosure more clearly, the present invention is described in detail with the accompanying drawings and the following embodiments.

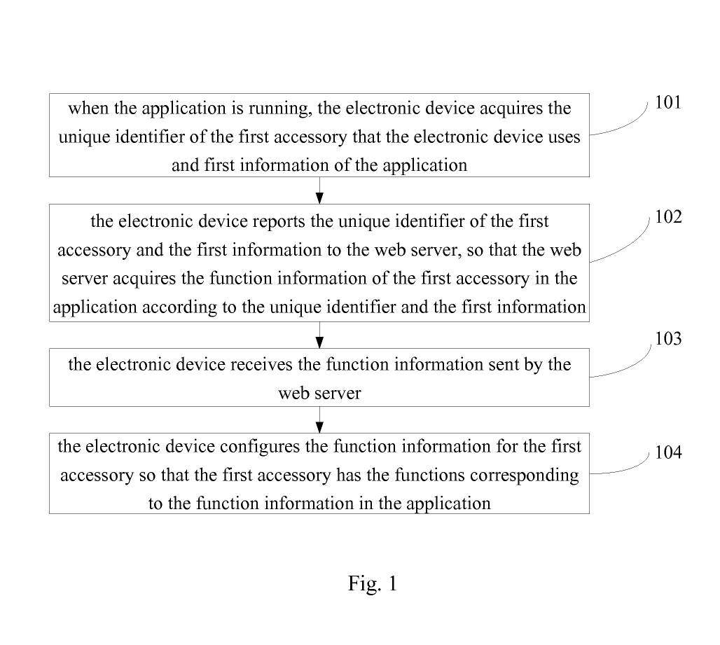

As shown in FIG. 1, the information processing method provided by the embodiment of the present disclosure is applied to an electronic device and a first accessory independent of the electronic device, the method includes the following steps:

At step 101, when an application is running, the electronic device acquires the unique identifier of the first accessory that the electronic device uses and first information of the application.

Specifically, the first accessory is applied to the operations of the application of the electronic device. For example, if the application is a checkers game, the first accessory can be chess pieces used in the game, but it is not limited thereto.

Specifically, the unique identifier may be a universally unique identifier (UUID). Specifically, each first accessory has the UUID, so that each first accessory can have unique identification information. Each first accessory establishes a UUID that is not in conflict with other first accessories, so that the name repetition problem does not need to be considered, but it is not limited thereto.

Specifically, the first information can include the application name, the version number of the application, and the user identifier applying the application. For example, if the application is a network game, the first information can carry the name, version number of the network game and the user name of the user who logs on to the game, but it is not limited thereto.

At step 102, the electronic device reports the unique identifier of the first accessory and the first information to the web server, so that the web server can acquire the function information of the first accessory in the application according to the unique identifier and the first information.

Specifically, the function information carries the function of the first accessory in the application. For example, when the first information indicates the application is a checkers game, the function of the first accessory in the checkers game is the chess piece function. For another example, when the first information indicates that the application is a card game, the function of the first accessory in the card game is the chip function, but it is not limited thereto.

Specifically, the correspondence relationship between the unique identifier of the first accessory and the function can be stored previously in the web server, so that after the web server receives the unique identifier and the first information, the function information of the first accessories in the application can be acquired.

At step 103, the electronic device receives the function information sent by the web server.

At step 104, the electronic device configures the function information for the first accessory so that the first accessory has the functions corresponding to the function information in the application.

In the information processing method of the electronic device accessory provided by the embodiment of the present disclosure, since when the application is running, the electronic device acquires the unique identifier of the first accessory that the electronic device uses and the first information of the application, and reports the unique identifier of the first accessory and the first information to the web server so that the web server can acquire the function information of the first accessory in the application according to the first unique identifier and the first information, after the electronic device receives the function information sent by the web server and configure it for the first accessory, the first accessory has the function corresponding to the function information in the application. When the first accessory is applied to different applications, it can perform the corresponding function through the function information in different applications, whereas the function of the accessory in the prior art is single and can be only applied to one application. Therefore, the present invention can lower the costs of the accessory application and make the accessory functions more diverse.

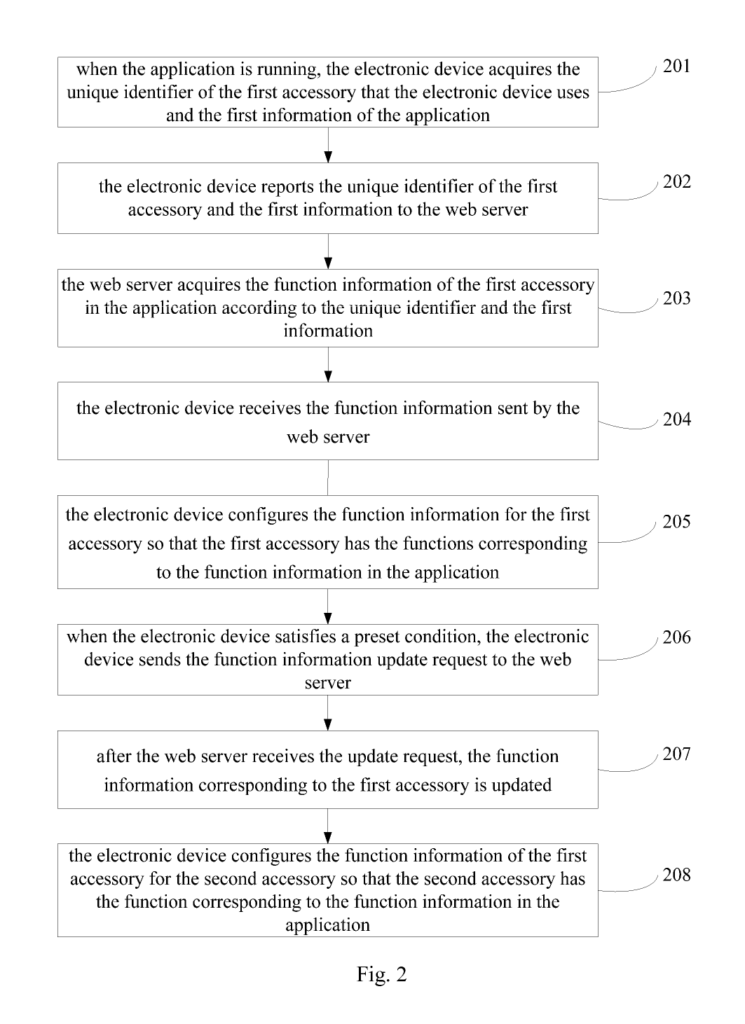

As shown in FIG. 2, the information processing method of the electronic device accessory provided by another embodiment of the present disclosure is applied to an electronic device and a first accessory independent of the electronic device. The method includes the following steps:

At step 201, when the application is running, the electronic device acquires the unique identifier of the first accessory that the electronic device uses and the first information of the application.

Specifically, the unique identifier may be a universally unique identifier (UUID). Specifically, each first accessory has the UUID, so that each first accessory can have unique identification information. Each first accessory establishes a UUID that is not in conflict with other first accessories, so that the name repetition problem does not need to be considered, but it is not limited thereto.

Specifically, the first information can include the application name, the version number of the application, and the user identifier that applies the application. For example, if the application is a network game, the first information can carry the name, version number of the network game and the user name of the user who logs on to the game, but it is not limited thereto.

At step 202, the electronic device reports the unique identifier of the first accessory and the first information to the web server.

At step 203, the web server acquires the function information of the first accessory in the application according to the unique identifier and the first information.

Specifically, the function information carries the function of the first accessory in the application. For example, when the first information indicates the application is a checkers game, the function of the first accessory in the checkers game is the chess piece function. For another example, when the first information indicates that the application is a card game, the function of the first accessory in the card game is the chip function, but it is not limited thereto.

Specifically, the correspondence relationship between a unique identifier of the first accessory and the function can be stored previously in the web server, so that after the web server receives the unique identifier and the first information, the function information of the first accessories in the application can be acquired.

At step 204, the electronic device receives the function information sent by the web server.

At step 205, the electronic device configures the function information for the first accessory so that the first accessory has the functions corresponding to the function information in the application.

Specifically, the first accessory can communicate with the electronic device via wireless communication technology. For example, it can communicate with the electronic device via Wi-Fi, but it is not limited thereto.

At step 206, when the electronic device satisfies a preset condition, the electronic device sends the function information update request to the web server.

Specifically, the preset condition may be the electronic device's acquiring that the preset trigger button on the electronic device is activated. The function information update request is used for the function request for the function of the first accessory. For example, in the checker game, the function of the first accessory is a chess piece function and the it is permitted to jump only one step, whereas when the user need the permission to jump two steps one time, a preset button in the checker game is required to be triggered so as to carry out the request, but it is not limited thereto.

At step 207, after the web server receives the update request, the function information corresponding to the first accessory is updated.

Specifically, the first information may include the user identifier that uses the application, wherein, the function information of the first accessory may be bound to the user identifier so as to facilitate the management control of the first accessory. For example, if the user needs the electronic device to run a network game, which needs to configure the first accessory for running, after the user has input the user identifier, such as account name and password, and played the game, the experience value and the authority etc. will accumulate in the account of the user, so the function information of the first accessory can update accordingly. The method proceeds to step 208.

At step 208, the electronic device configures the function information of the first accessory for the second accessory so that the second accessory has the function corresponding to the function information in the application.

Specifically, when the first accessory is lost or damaged, in order to ensure that the function information of the first accessory of the user corresponding to the user identifier can be used continually, the function information of the first accessory can be configured for the second accessory, but it is not limited thereto.

In the information processing method of the electronic device accessory provided by another embodiment of the present disclosure, since when the application is running, the electronic device acquires the unique identifier of the first accessory that the electronic device uses and the first information of the application, and reports the unique identifier of the first accessory and the first information to the web server so that the web server can acquire the function information of the first accessory in the application according to the first unique identifier and the first information, after the electronic device receives the function information sent by the web server and configures it for the first accessory, the first accessory has the function corresponding to the function information in the application. When the first accessory is applied to different applications, it can perform the corresponding function through the function information in different applications, whereas the function of the accessory in the prior art is single and can be only applied to one application. Therefore, the present invention can lower the costs of the accessory application and make the accessory functions more diverse.

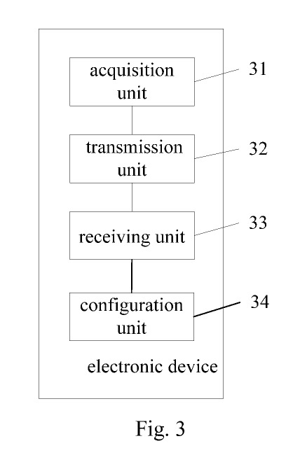

As shown in FIG. 3, the electronic device provided by an embodiment of the present invention includes the following units.

An acquisition unit 31, the acquisition unit 31 is configured to acquire the unique identifier of the first accessory that the electronic device uses and the first information of the application, when the application is running. The specific implementation is shown in step 101 in FIG. 1, and will not be repeated herein.

A transmission unit 32, the transmission unit 32 is configured to report the unique identifier of the first accessory and the first information to the web server, so that the web server acquires the function information of the first accessory in the application according to the unique identifier and the first information. The specific implementation is shown in step 102 in FIG. 1, and will not be repeated herein.

A receiving unit 33, the receiving unit 33 is configured to receive the function information sent by the web server. The specific implementation is shown in step 103 in FIG. 1, and will not be repeated herein.

A configuration unit 34, the configuration unit 34 is configured to configure the function information for the first accessory so that the first accessory has the functions corresponding to the function information in the application. The specific implementation is shown in step 104 in FIG. 1, and will not be repeated herein.

Further, as shown in FIG. 3, the transmission unit 32 is further configured to, when the electronic device satisfies a preset condition, send the function information update request to the web server, so that the web server can update function information corresponding to the first accessory.

Specifically, as shown in FIG. 3, the transmission unit 32 is particularly configured to send the function information update request to the web server when acquiring that a preset trigger button on the electronic device is activated.

Specifically, the first information may include the user identifier that uses the application, and the function information of the first accessory may be bound to the user identifier.

Further, as shown in FIG. 3, the configuration unit 34 is further configured to configure the function information of the first accessory for the second accessory so that the second accessory has the function corresponding to the function information in the application.

Specifically, the first information may further include the application name, application version number. The unique identifier is a universal unique identifier UUID, but it is not limited thereto.

With the electronic device provided by the embodiment of the present disclosure, since when the application is running, the electronic device acquires the unique identifier of the first accessory that the electronic device uses and the first information of the application, and reports the unique identifier of the first accessory and the first information to the web server so that the web server can acquire the function information of the first accessory in the application according to the first unique identifier and the first information, after the electronic device receives the function information sent by the web server and configure it for the first accessory, the first accessory has the function corresponding to the function information in the application. When the first accessory is applied to different applications, it can perform the corresponding function through the function information in different applications. Whereas the function of the accessory in the prior art is single and can be only applied to one application. Therefore, the present invention can lower the costs of the accessory application and make the accessory functions more diverse.

An electronic device accessory is provided, and the accessory has a unique identifier.

Specifically, the unique identifier may be a universal unique identifier UUID, but it is not limited thereto.

The accessory can be, for example, game pieces, dice, etc., but it is not limited thereto.

Through the description of the above described embodiments, those skilled in the art may understand that the present invention may be implemented by software plus necessary general hardware or, of course, by hardware. But in many cases, the former is a better embodiment. Based on such understanding, the technical solution of the present disclosure or the part contributing to the prior art may be embodied substantially in the form of a software product, which can be stored in the readable storage medium, such as a floppy disk of a computer, a hard disk or an optical disk etc., including several instructions to instruct a computer device (which may be a personal computer, a server, or network equipment, etc.) to implement the method of various embodiments of the present invention.

The above description is only for specific embodiments of the present disclosure, but the protection scope of the present disclosure is not limited thereto. The variations or replacements that can be easily thought by the skilled in the art are all within the protection scope of the present disclosure. Accordingly, the protection scope of the present disclosure should be defined by the scope of the claims.

1. An information processing method for a electronic device accessory, applied to an electronic device and a first accessory independent of the electronic device, the method comprising:
when an application is running, acquiring the unique identifier of the first accessory that electronic device uses and first information of the application;
reporting the unique identifier of the first accessory and the first information to the web server, so that the web server acquires the function information of the first accessory in the application according to the unique identifier and the first information;
receiving the function information sent by the web server; and,
configuring the function information for the first accessory so that the first accessory has functions corresponding to the function information in the application.

2. The method according to claim 1, further comprising when the electronic device satisfies a preset condition, sending the function information update request to the web server, so that the web server updates the function information corresponding to the first accessory.

3. The method according to claim 2, wherein the sending the function information update request further comprises, when the electronic device acquires that the preset trigger button on the electronic device is activated, sending the function information update request to the web server.

4. The method according to claim 1, wherein the first information comprises the user identifier that uses the application, and the function information of the first accessory is bound to the user identifier.

5. The method according to claim 4, wherein the method further comprising configuring the function information of the first accessory for the second accessory, so that the second accessory has the function corresponding to the function information in the application.

6. The method according to claim 1, wherein the first information further comprises application name, application version number, and the unique identifier is a universal unique identifier (“UUID”).

7. An electronic device, comprising:
an acquisition unit configured to acquire the unique identifier of the first accessory that the electronic device uses and the first information of an application when the application is run;
a transmission unit configured to report the unique identifier of the first accessory and the first information to the web server, so that the web server acquires the function information of the first accessory in the application according to the unique identifier and the first information;
a receiving unit configured to receive the function information sent by the web server;
a configuration unit configured to configure the function information for the first accessory so that the first accessory has the functions corresponding to the function information in the application.

8. The electronic device according to claim 7, wherein the transmission unit is further configured to send the function information update request to the web server so that the web server updates the function information corresponding to the first accessory when the electronic device satisfies a preset condition.

9. The electronic device according to claim 8, wherein the transmission unit is specifically configured to send the function information update request to the web server when the electronic device acquires that the preset trigger button on the electronic device is activated.

10. The electronic device according to claim 7, wherein the first information comprises the user identifier that uses the application, and the function information of the first accessory is bound to the user identifier.

11. The electronic device according to claim 10, wherein the configuration unit is further configured to configure the function information of the first accessory for the second accessory so that the second accessory has the function corresponding to the function information in the application.

12. The electronic device according to claim 7, wherein the first information further comprises application name, application version number, and the unique identifier is a UUID.

13. An accessory of an electronic device, wherein the accessory has a unique identifier.

14. The accessory according to claim 13, wherein the unique identifier is a universal unique identifier UUID.
